(19) United States
(12) Patent Application Publication
(10) Pub. No.: US 2025/0302161 A1
(43) Pub. Date: Oct. 2, 2025

(54) MOBILITY AND EXERCISE DEVICE

(71) Applicant: Katarzyna Baraniecka, London (CA)

(72) Inventor: Katarzyna Baraniecka, London (CA)

(21) Appl. No.: 19/054,983

(22) Filed: Feb. 17, 2025

Related U.S. Application Data
(60) Provisional application No. 63/570,261, filed on Mar. 27, 2024.

(51) Int. Cl. A45B 9/04; A45B 3/00; A45B 9/00; A45B 9/02; A63B 23/12

(52) U.S. Cl. CPC A45B 9/04; A45B 3/00; A45B 9/02; A63B 23/1263; A45B 2009/002; A45B 2009/007; A45B 2200/05

(57) ABSTRACT

The subject matter disclosed and claimed herein, in one embodiment thereof, comprises a roll-walk device. The device is a pair of walking sticks or poles that enables users to exercise their upper body by mimicking (i.e., the arm and upper body movements of) a walking, hiking, and/or skiing motion while sitting down. The base of each walking stick or pole features an interchangeable mechanism that enables users to swap out the standard base with a set of wheels. Thus, once the device is equipped with the wheels, the user can sit comfortably while mimicking (i.e., the arm and upper body movements of) a walking, hiking, and/or skiing motion to exercise their upper body.

### CROSS-REFERENCE TO RELATED APPLICATION

The present application claims priority to, and the benefit of, U.S. Provisional Application No. 63/570,261, which was filed on Mar. 27, 2024, and is incorporated herein by reference in its entirety.

### FIELD OF THE INVENTION

The present invention relates generally to the field of mobility and exercise devices. More specifically, the present invention relates to walking sticks that can be equipped with wheels on the base to facilitate exercise. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in mobility and exercise devices. Generally, individuals with mobility issues due to age, injury, and other conditions may need to use walkers, a cane, walking sticks, or wheelchairs to move around independently. Without assistance, individuals with these issues may lack the means to exercise, especially during inclement weather. Individuals may not be able to afford a gym membership or home gym exercise equipment to maintain a healthy lifestyle. Additionally, lack of mobility prohibits individuals from accessing exercise equipment.

Accordingly, there is a demand for an improved roll-walk device that functions both as a mobility aid and as exercise equipment. More particularly, there is a demand for a roll-walk device that is comprised of walking sticks that can be equipped with wheels on each base to facilitate upper body exercise while in a sitting position.

Therefore, there exists a long felt need in the art for a roll-walk device that provides users with a set of walking sticks that can be equipped with wheels on the base to facilitate exercise. There is also a long felt need in the art for a roll-walk device that enables users to interchange the standard walking stick tips with wheels, sit in a chair, and mimic a walking, hiking, and/or skiing motion to exercise the upper body. Further, there is a long felt need in the art for a roll-walk device that enables users to adjust the walking sticks to different heights to accommodate individuals of different sizes and to utilize the device as standard walking sticks or exercise tools. Finally, there is a long felt need in the art for a roll-walk device that offers a way for individuals with mobility issues to maintain a healthy lifestyle, ensuring they can still perform upper body exercises without having to leave their home.

The subject matter disclosed and claimed herein, in one embodiment thereof, comprises a roll-walk device. The device is a pair of walking sticks or poles that enables users to exercise their upper body by mimicking (i.e., the arm and upper body movements of) a walking, hiking, and/or skiing motion while sitting down. The base of each walking stick or pole features an interchangeable mechanism that enables users to swap out the standard base with a set of wheels (i.e., a set of wheels). Thus, once the device is equipped with the wheels, the user can sit comfortably while mimicking (i.e., the arm and upper body movements of) a walking, hiking, and/or skiing motion to exercise their upper body. Accordingly, the device functions both as a mobility aid or exercise equipment.

In this manner, the roll-walk device of the present invention accomplishes all of the forgoing objectives and provides users with a mobility device that also functions as exercise equipment.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a roll-walk device. The device is comprised of a pair of walking sticks or poles that enable users to exercise their upper body by mimicking (i.e., the arm and upper body movements of) a walking, hiking, and/or skiing motion while sitting down. The base of each walking stick or pole features an interchangeable mechanism that enables users to swap out the standard base with a set of wheels. Thus, once the device is equipped with the wheels, the user can sit comfortably while mimicking (i.e., the arm and upper body movements of) a walking, hiking, and/or skiing motion to exercise their upper body.

In one embodiment, the roll-walk device comprises a pair of telescoping sticks or poles. The telescoping sticks or poles are typically configured in a cylindrical shape but can be configured in any suitable shape as is known in the art. Generally, the telescoping sticks or poles are comprised of a top portion, a bottom portion, holes, spring-loaded locking pins, handles, and wrist straps.

In one embodiment, holes and spring-loaded locking pins along the length of each telescoping stick or pole enable for vertical adjustment to accommodate the height of each user. In one embodiment, the bottom portion of each telescoping stick or pole is slightly smaller in diameter than the top portion, such that the bottom portions can slide (i.e., telescope) into the top portions as the telescoping sticks or poles are vertically adjusted.

In one embodiment, the handles located on the ends of the top portions of each of the telescoping sticks or poles are ergonomic in shape, and feature wrist straps to further ensure a secure grip.

In one embodiment, the roll-walk device also comprises a set of standard bases and a set of wheels that can be removably attached to the end of the bottom portion of each telescoping stick or pole.

In one embodiment, the roll-walk device in accordance with the present invention can be produced in various colors, designs, patterns, etc., and feature logos, emblems and or designs, such as a distributor requests and/or a user desires.

In one embodiment, the roll-walk device is manufactured of a high-density polyethylene (HDPE), or any other suitable materials as is known in the art. Any number of different types of materials can be used to make the roll-walk device including but not limited to plastics, metal, etc.

In use, the user removes the standard bases from the bottom portions of both telescoping sticks or poles. Further, the user attaches the wheels to the bottom portions of both telescoping sticks or poles. Further, the user vertically adjusts the telescoping sticks or poles to suit their height. Thus, once the device is equipped with the wheels (i.e., roller balls), the user can sit comfortably while mimicking (i.e., the arm and upper body movements of) a walking, hiking, and/or skiing motion to exercise their upper body. Accordingly, the device provides users with a set of walking sticks that can be used as mobility aids or as exercise equipment. The device offers a way for individuals with mobility issues to maintain a healthy lifestyle, ensuring they can still perform upper body exercises without having to leave their home.

It will also be appreciated that there are a number of additional add-on features that can be incorporated into the device and moreover, the roll-walk device can take many different forms as is known in the art.

In yet another embodiment, the roll-walk device comprises a plurality of indicia.

In yet another embodiment, method of conveniently swapping out the standard bases for the wheels (i.e., roller balls) in order to utilize the roll-walk device for exercise is disclosed. The method includes the steps of providing a roll-walk device comprising a pair of telescoping sticks or poles with interchangeable standard bases and sets of wheels. The method also comprises removing the standard bases from the bottom portions of both telescoping sticks or poles. Further, the method comprises attaching the wheels (i.e., roller balls) to the bottom portions of both telescoping sticks or poles. Further, the method comprises vertically adjusting the telescoping sticks or poles to suit the height of the user. Finally, the method comprises utilizing the device to exercise the upper body by mimicking (i.e., the arm and upper body movements of) a walking, hiking, and/or skiing motion with the arms.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the roll-walk device of the present invention showing the telescoping sticks or poles in use for upper body exercises in accordance with the disclosed architecture;

FIG. 2 illustrates a perspective view of one embodiment of the roll-walk device of the present invention showing a close-up of the telescoping stick or pole handles in accordance with the disclosed architecture;

FIG. 3 illustrates a perspective view of one embodiment of the roll-walk device of the present invention showing how the standard bases of the telescoping sticks or poles can be interchanged with wheels (i.e., roller balls) in accordance with the disclosed architecture;

FIG. 4 illustrates another perspective view of one embodiment of the roll-walk device of the present invention showing how the standard bases of the telescoping sticks or poles can be interchanged to roller balls in accordance with the disclosed architecture;

FIG. 5 illustrates a perspective view of one embodiment of the roll-walk device of the present invention showing a user utilizing the device while standing in accordance with the disclosed architecture; and

FIG. 6 illustrates a flowchart of the method of conveniently swapping out the standard bases for the wheels (i.e., roller balls) in order to utilize the roll-walk device for exercise.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a roll-walk device that provides users with a set of walking sticks that can be equipped with wheels on the base to facilitate exercise. There is also a long felt need in the art for a roll-walk device that enables users to interchange the standard walking stick tips with wheels, sit in a chair, and mimic a walking, hiking, and/or skiing motion to exercise the upper body. Further, there is a long felt need in the art for a roll-walk device that enables users to adjust the walking sticks to different heights to accommodate individuals of different sizes and to utilize the device as standard walking sticks or exercise tools. Finally, there is a long felt need in the art for a roll-walk device that offers a way for individuals with mobility issues to maintain a healthy lifestyle, ensuring they can still perform upper body exercises without having to leave their home.

The present invention, in one exemplary embodiment, is a novel roll-walk device that can be used both as a mobility aid as exercise equipment. The device is comprised of a pair of walking sticks or poles that enable users to exercise their upper body by mimicking (i.e., the arm and upper body movements of) a walking, hiking, and/or skiing motion while sitting down. The base of each walking stick or pole features an interchangeable mechanism that enables users to swap out the standard base with a set of wheels. Thus, once the device is equipped with the wheels, the user can sit comfortably while mimicking (i.e., the arm and upper body movements of) a walking, hiking, and/or skiing motion to exercise their upper body. The present invention also includes a novel method of conveniently swapping out the standard bases for the wheels (i.e., roller balls) in order to utilize the roll-walk device for exercise. The method includes the steps of providing a roll-walk device comprising a pair of telescoping sticks or poles with interchangeable standard bases and sets of wheels. The method also comprises removing the standard bases from the bottom portions of both telescoping sticks or poles. Further, the method comprises attaching the wheels (i.e., roller balls) to the bottom portions of both telescoping sticks or poles. Further, the method comprises vertically adjusting the telescoping sticks or poles to suit the height of the user. Finally, the method comprises utilizing the device to exercise the upper body by mimicking (i.e., the arm and upper body movements of) a walking, hiking, and/or skiing motion with the arms.

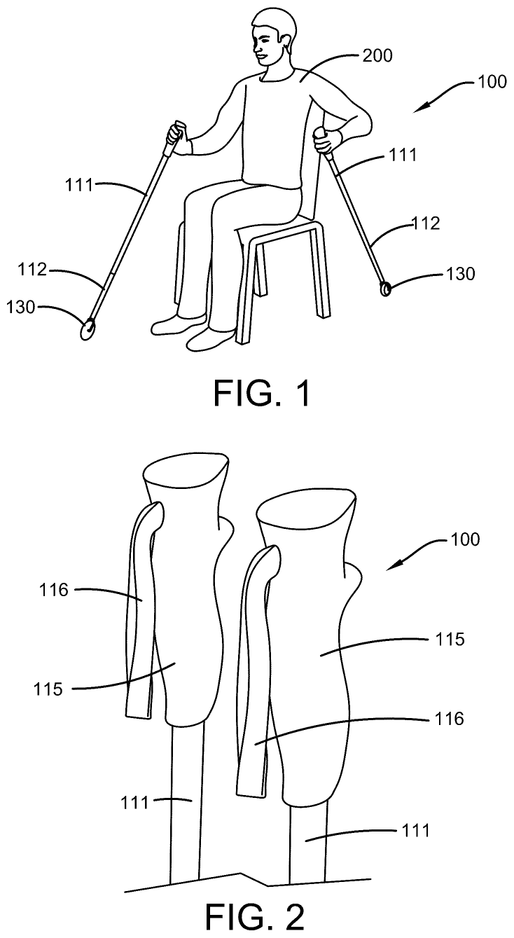

Referring initially to the drawings, FIG. 1 illustrates a perspective view of one embodiment of the roll-walk device 100 of the present invention being used to perform upper body exercises. In the present embodiment, the roll-walk device 100 is an improved roll-walk device 100 that provides a user 200 with a pair of telescoping sticks or poles 110 that feature interchangeable standard bases 120 and sets of wheels or roller balls 130. Thus, the device 100 can be used as a traditional mobility aid or exercise equipment. Once the standard bases 120 are swapped out for wheels or roller balls 130, the device 100 can be used to exercise the upper body by mimicking (i.e., the arm and upper body movements of) a walking, hiking, and/or skiing motion with the arms.

As shown in FIG. 2, the roll-walk device 100 comprises a pair of telescoping sticks or poles 110. The telescoping sticks or poles 110 are typically configured in a cylindrical shape but can be configured in any suitable shape as is known in the art. Generally, the telescoping sticks or poles 110 are comprised of a top portion 111, a bottom portion 112, holes 113, spring-loaded locking pins 114, handles 115, and wrist straps 116.

Further, and also as shown in FIG. 2, the handles 115 located on the ends of the top portions 111 of each of the telescoping sticks or poles 110 are ergonomic in shape, and feature wrist straps 116 to further ensure a secure grip.

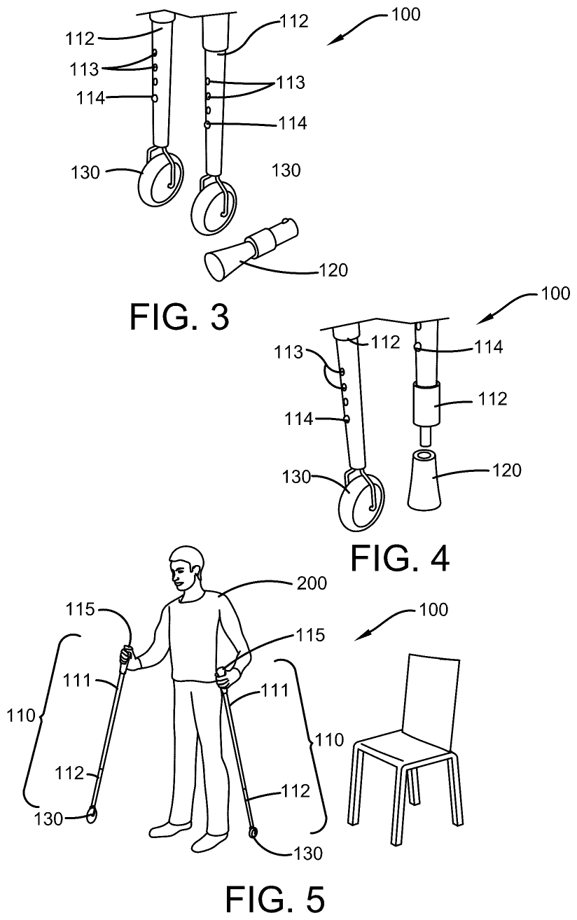

As shown in FIGS. 3 and 4, the roll-walk device 100 comprises a set of standard bases 120 and a set of wheels or roller balls 130 that can be removably attached to the end of the bottom portion 112 of each telescoping stick or pole 110. Holes 113 and spring-loaded locking pins 114 along the length of each telescoping stick or pole 110 enable for vertical adjustment to accommodate the height of each user 200. The bottom portion 112 of each telescoping stick or pole 110 is slightly smaller in diameter than the top portion 111, such that the bottom portions 112 can slide into the top portions 111 as the telescopic stick(s) or pole(s) is/are vertically adjusted.

As shown in FIGS. 1 and 5, in use, the user 200 removes the standard bases 120 from the bottom portions 112 of both telescoping sticks or poles 110. Further, the user 200 attaches the wheels (i.e., roller balls) 130 to the bottom portions 112 of both telescoping sticks or poles 110. Further, the user 200 vertically adjusts the telescoping sticks or poles 110 to suit their height. Thus, once the device 100 is equipped with the wheels (i.e., roller balls) 130, the user 200 can sit comfortably while mimicking (i.e., the arm and upper body movements of) a walking, hiking, and/or skiing motion to exercise their upper body. Accordingly, the device 100 provides users with a set of walking sticks that can be used as mobility aids or as exercise equipment. The device 100 offers a way for individuals with mobility issues to maintain a healthy lifestyle, ensuring they can still perform upper body exercises without having to leave their home.

It is to be appreciated that the roll-walk device 100 in accordance with the present invention can be produced in various colors, designs, patterns, etc., and feature logos, emblems and or designs, such as a distributor requests and/or a user 200 desires.

In one embodiment, the roll-walk device 100 is manufactured of a high-density polyethylene (HDPE), or any other suitable materials as is known in the art. Any number of different types of materials can be used to make the roll-walk device 100 including but not limited to metals, heat-sealable plastic or polymers, such as polypropylene or acrylonitrile-butadiene-styrene (ABS), or any other suitable material as is known in the art, such as but not limited to, acrylic, polycarbonate, polyethylene, polyethylene terephthalate, polyvinyl chloride, polystyrene, etc.

In yet another embodiment, the roll-walk device 100 comprises a plurality of indicia 400. The telescoping sticks or poles 110 of the device 100 may include advertising, a trademark, or other letters, designs, or characters, printed, painted, stamped, or integrated into the telescoping sticks or poles 110, or any other indicia 400 as is known in the art. Specifically, any suitable indicia 400 as is known in the art can be included, such as but not limited to, patterns, logos, emblems, images, symbols, designs, letters, words, characters, animals, advertisements, brands, etc., that may or may not be walking, exercise, or brand related.

It will also be appreciated that there are a number of additional add-on features that can be incorporated into the device 100 and moreover, the roll-walk device 100 can take many different forms as is known in the art.

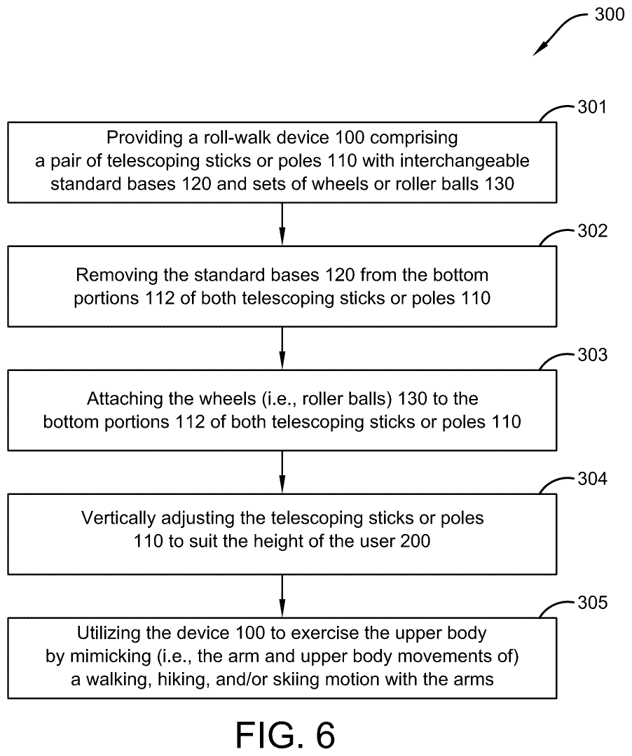

FIG. 6 illustrates a flowchart of the method 300 of conveniently swapping out the standard bases 120 for the wheels (i.e., roller balls) 130 in order to utilize the roll-walk device 100 for exercise. The method 300 includes the steps of at 301, providing a roll-walk device 100 comprising a pair of telescoping sticks or poles 110 with interchangeable standard bases 120 and sets of wheels or roller balls 130. The method 300 also comprises at 302, removing the standard bases 120 from the bottom portions 112 of both telescoping sticks or poles 110. Further, the method 300 comprises at 303, attaching the wheels (i.e., roller balls) 130 to the bottom portions 112 of both telescoping sticks or poles 110. Further, the method 300 comprises at 304, vertically adjusting the telescoping sticks or poles 110 to suit the height of the user 200. Finally, the method 300 comprises at 305, utilizing the device 100 to exercise the upper body by mimicking (i.e., the arm and upper body movements of) a walking, hiking, and/or skiing motion with the arms.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “roll-walk device”, “walking stick device”, “exercise device”, and “device” are interchangeable and refer to the roll-walk device 100 of the present invention.

Notwithstanding the forgoing, the roll-walk device 100 of the present invention can be of any suitable size and configuration as is known in the art without affecting the overall concept of the invention, provided that it accomplishes the above stated objectives. One of ordinary skill in the art will appreciate that the roll-walk device 100 as shown in FIGS. 1-5 is for illustrative purposes only, and that many other sizes and shapes of the roll-walk device 100 are well within the scope of the present disclosure. Although the dimensions of the roll-walk device 100 are important design parameters for user convenience, the roll-walk device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A roll-walk device for exercising the upper body comprising:
a first telescoping pole;
a first interchangeable base; and
a first wheel;
wherein said first interchangeable base selectively removable from said first telescoping pole; and
further wherein said first wheel selectively mountable to said first telescoping pole.

2. The roll-walk device for exercising the upper body of claim 1 further comprising a second telescoping pole, a second interchangeable base, and a second wheel, wherein said second interchangeable base selectively removable from said second telescoping pole, and further wherein said second wheel selectively mountable to said second telescoping pole.

3. The roll-walk device for exercising the upper body of claim 2, wherein said first wheel is a first roller ball.

4. The roll-walk device for exercising the upper body of claim 3, wherein said second wheel is a second roller ball.

5. The roll-walk device for exercising the upper body of claim 2, wherein said first telescoping pole and said second telescoping pole selectively interchangeable from fixed poles to wheeled poles for mimicking arm movements of a hiker.

6. The roll-walk device for exercising the upper body of claim 2, wherein said first telescoping pole and said second telescoping pole selectively interchangeable from fixed poles to wheeled poles for mimicking arm movements of a skier.

7. The roll-walk device for exercising the upper body of claim 2, wherein said first telescoping pole and said second telescoping pole are cylindrical.

8. The roll-walk device for exercising the upper body of claim 1, wherein said first telescoping pole having a top portion, a bottom portion, a plurality of holes, a spring-loaded locking pin, a handle, and a wrist strap, and further wherein said spring-loaded locking pin selectively positionable in at least one of said plurality of holes for adjusting a length of said first telescoping pole.

9. A roll-walk device for exercising the upper body comprising:
a first telescoping pole;
a first interchangeable base;
a first wheel;
a second telescoping pole;
a second interchangeable base; and
a second wheel;
wherein said first interchangeable base selectively removable from said first telescoping pole;
wherein said first wheel selectively mountable to said first telescoping pole;
wherein said second interchangeable base selectively removable from said second telescoping pole;
wherein said second wheel selectively mountable to said second telescoping pole; and
further wherein said first telescoping pole and said second telescoping pole selectively interchangeable from fixed poles to wheeled poles for mimicking arm movements of a hiker.

10. The roll-walk device for exercising the upper body of claim 9, wherein said first wheel is a first roller ball.

11. The roll-walk device for exercising the upper body of claim 10, wherein said second wheel is a second roller ball.

12. The roll-walk device for exercising the upper body of claim 11, wherein said first telescoping pole and said second telescoping pole selectively interchangeable from fixed poles to wheeled poles for mimicking arm movements of a skier.

13. The roll-walk device for exercising the upper body of claim 11, wherein said first telescoping pole and said second telescoping pole are cylindrical.

14. The roll-walk device for exercising the upper body of claim 13, wherein said first telescoping pole having a top portion, a bottom portion, a plurality of holes, a spring-loaded locking pin, a handle, and a wrist strap, and further wherein said spring-loaded locking pin selectively positionable in at least one of said plurality of holes for adjusting a length of said first telescoping pole.

15. A method of using a roll-walk device for exercising the upper body, the method comprising the following steps:
providing a first telescoping pole, a first interchangeable base, a first wheel, a second telescoping pole, a second interchangeable base, and a second wheel;
selectively removing said first interchangeable base from said first telescoping pole;
selectively mounting said first wheel to said first telescoping pole;
selectively removing said second interchangeable base from said second telescoping pole;
selectively mounting said second wheel to said second telescoping pole, wherein said first telescoping pole and said second telescoping pole selectively interchangeable from fixed poles to wheeled poles for mimicking arm movements of a hiker.

16. The method of using the roll-walk device for exercising the upper body of claim 15, wherein said first wheel is a first roller ball.

17. The method of using the roll-walk device for exercising the upper body of claim 16, wherein said second wheel is a second roller ball.

18. The method of using the roll-walk device for exercising the upper body of claim 17, wherein said first telescoping pole and said second telescoping pole selectively interchangeable from fixed poles to wheeled poles for mimicking arm movements of a skier.

19. The method of using the roll-walk device for exercising the upper body of claim 18, wherein said first telescoping pole and said second telescoping pole are cylindrical.

20. The method of using the roll-walk device for exercising the upper body of claim 19, wherein said first telescoping pole having a top portion, a bottom portion, a plurality of holes, a spring-loaded locking pin, a handle, and a wrist strap, and further wherein said spring-loaded locking pin selectively positionable in at least one of said plurality of holes for adjusting a length of said first telescoping pole.
